(19) United States
(12) Patent Application Publication
(10) Pub. No.: US 2026/0196036 A1
(43) Pub. Date: Jul. 9, 2026

(54) SYSTEM, MOVING BODY, AND SERVER COMPUTER

(71) Applicant: Hitachi, Ltd., Chiyoda-ku, Tokyo (JP)

(72) Inventors: Goichi ONO, Tokyo (JP); Akira KITAYAMA, Tokyo (JP); Riu HIRAI, Tokyo (JP)

(21) Appl. No.: 19/131,639

(22) PCT Filed: Jul. 31, 2023
(86) PCT No.: PCT/JP2023/027898

§ 371 Date: May 21, 2025

(30) Foreign Application Priority Data
Dec. 9, 2022 (JP) 2022-197283

(51) Int. Cl. G06V 10/96; G06V 10/74; G06V 10/774; G06V 10/94; G06V 20/58

(52) U.S. Cl. CPC G06V 10/96; G06V 10/74; G06V 10/774; G06V 10/95; G06V 20/58

(57) ABSTRACT

A system including a moving, body side processor system and a server side processor system. The moving body side processor system stores data collection condition, an environment recognition model, an existence probability calculation program, and a data collection program. The moving body side processor system calculates a ratio of an occurrence frequency of an event matching a predetermined data collection condition as an existence probability. A memory resource of the server side processor system stores data collection condition and a collection condition allocation program, and by executing the collection condition allocation program, uses the existence probability calculated by the moving body side processor system to allocate a data collection condition corresponding to the moving body under the data collection environment. The moving body side processor system collects image data matching the data collection condition allocated to the moving body from the image data captured by the camera.

### TECHNICAL FIELD

The present invention relates to a system, a moving body, and a server computer. The invention claims the priority of Japanese Patent Application No. 2022-197283 filed on Dec. 9, 2022, and the contents described in the application are incorporated into the present application by reference in the designated country where incorporation by reference of literatures is permitted.

### BACKGROUND ART

In recent years, in a technical field such as autonomous driving assistance, an image recognition technique of an AI model using an artificial intelligence (AI) has been used. In a system using an AI model, machine learning of the AI model using training data is repeatedly performed for the purpose of improving performance and quality or expanding an application scene.

It is known that the AI model efficiently improves performance, quality, and the like by performing machine learning using more training data according to maturity. As an example of an AI model that performs autonomous driving assistance, in a stage where the maturity is low, performance and the like are efficiently improved by using more image data containing a large number of vehicles one scene (one image) as training data. In addition, in the AI model, as the maturity increases, the number of vehicles included in one scene decreases, and more image data in which a distance between objects (vehicles, a vehicle, a bicycle, or the like) is short is used as the training data, so that the performance or the like is efficiently improved.

Therefore, in such a system, in machine learning of the AI model, it is required to efficiently collect more training data having different contents according to a degree of maturity of the AI model and a priority thereof.

PTL 1 discloses a data collection system that collects data effective for training of a training model. Specifically, PTL 1 discloses that “a data collection system according to the present disclosure includes a sensor device that collects data, a training model that performs an output according to a training result with respect to an input, and a server device including a data analysis unit that identifies data effective for training of the training model or insufficient data, in which the server device transmits a request signal for collecting the data effective for training identified by the data analysis unit, the insufficient data, or data similar to the data to the sensor device, the sensor device collects the data effective for training, the insufficient data, or similar data based on the received request signal, and transmits the collected data to the server device, and the server device performs re-training of the training model based on the data transmitted from the sensor device”.

### CITATION LIST

### Patent Literature

PTL 1: WO 2022/009652

### SUMMARY OF INVENTION

### Technical Problem

PTL 1 discloses that a server device transmits a collection request for the data effective for training of a training model to a sensor device, and the server device performs the re-training of the training model based on the data collected by the sensor device. However, in the technique of PTL 1, it is not considered to efficiently collect the training data having different contents according to maturity of an AI model.

The invention has been made in view of the above problems, and an object thereof is to more efficiently collect necessary data.

### Solution to Problem

The present application includes a plurality of units for solving at least a part of the above problems, and examples thereof are as follows. A system according to an aspect of the invention for solving the above problem is a system including: a moving body side processor system mounted on each of a plurality of moving bodies and including a processor and a memory resource; and a server side processor system that is communicable with the moving body side processor system, that is mounted on a server computer, and that includes a processor and a memory resource. The memory resource of the moving body side processor system stores at least a data collection condition, an environment recognition model, an existence probability calculation program, and a data collection program, by executing the existence probability calculation program, the processor of the moving body side processor system calculates, based on a recognition result of a data collection environment in which the moving body is located, the recognition result being output by the environment recognition model using image data captured by a camera of the moving body, and the data collection condition, a ratio of an occurrence frequency of an event matching a predetermined data collection condition under the data collection environment as an existence probability of the data collection environment for the data collection condition, the memory resource of the server side processor system stores at least the data collection condition and a collection condition allocation program, by executing the collection condition allocation program, the processor of the server side processor system uses the existence probability calculated by the moving body side processor system to allocate a data collection condition corresponding to the moving body under the data collection environment in which the occurrence frequency of the event matching the data collection condition is higher, and by executing the data collection program, the processor of the moving body side processor system collects image data matching the data collection condition allocated to the moving body from the image data captured by the camera.

### Advantageous Effects of Invention

According to the invention, necessary data can be collected more efficiently.

### BRIEF DESCRIPTION OF DRAWINGS

FIG. 1 is a diagram showing an example of a schematic configuration of a moving body side processor system.

FIG. 2 is a diagram showing an example of collection condition information.

FIG. 3 is a diagram showing an example of an existence probability of a data collection environment for a collection condition.

FIG. 4 is a diagram showing an example of a change in the data collection environment for the collection condition.

FIG. 5 is a diagram showing an example of a schematic configuration of a server side processor system.

FIG. 6 is a diagram showing an example of a flow of data in a system according to a first embodiment.

FIG. 7 is a flowchart showing an example of processing of the moving body side processor system and the server side processor system.

FIG. 8 is a diagram showing an example of the existence probability of each moving body with respect to the collection condition.

FIG. 9 is a diagram showing an example of a change in the existence probability.

FIG. 10 is a diagram showing an example of efficiency comparison related to data collection in a system and a method in the related art.

FIG. 11 is a diagram showing an example of a flow of data in a system according to a second embodiment.

FIG. 12 is a diagram showing an example of a training loss function used for parameter update.

### DESCRIPTION OF EMBODIMENTS

Hereinafter, each embodiment of the invention will be described with reference to the drawings.

### <Schematic Configuration of System>

The present system includes a processor system of a server device (hereinafter, may be referred to as a “server side processor system”) and a processor system mounted on a moving body (hereinafter, may be referred to as a “moving body side processor system”). The server side processor system and the moving body side processor system are communicably connected to each other via a predetermined communication network (for example, the Internet, a local area network (LAN), or a wide area network (WAN)).

The present system relates to collection of training data to be used for machine learning of an AI model, and enables more efficient collection of training data by requesting a moving body in an environment in which an occurrence frequency of an event matching a collection condition is higher to collect the training data matching the collection condition.

Specifically, in the present system, according to the data collection environment of the moving body identified by the moving body side processor system, the server side processor system requests the moving body under an environment suitable for a desired data collection condition to collect data matching the collection condition.

In addition, the server side processor system performs machine learning an AI model (hereinafter, may be referred to as an “environment recognition model”) that performs environment recognition (image recognition) of the moving body using the data collected by the moving body side processor system, and updates parameters of the environment recognition model in consideration of a priority of the collection data.

The moving body side processor system acquires the updated environment recognition model from the server side processor system, and replaces the environment recognition model in the moving body side processor system with the updated environment recognition model.

With the present system, it is possible to more efficiently collect the training data to be used for the machine learning of the environment recognition model. In particular, the server side processor system can efficiently collect the training data having different contents according to the maturity of the environment recognition model. Accordingly, in the present system, it is possible to reduce a time required for the data collection and to reduce the number of moving bodies that perform the data collection.

In addition, since the time required for the data collection is shortened, the server side processor system can update the parameters of the environment recognition model in a short cycle. Therefore, the present system can contribute to achievement of high environment recognition performance in the moving body.

Hereinafter, each configuration and processing of the moving body side processor system and the server side processor system according to the first embodiment will be described in detail. The moving body on which the moving body processor system is mounted is not limited to an automobile, but in the present embodiment, the following description will be made taking an automobile as an example.

### First Embodiment

### <Configuration of Moving Body Side Processor System 100>

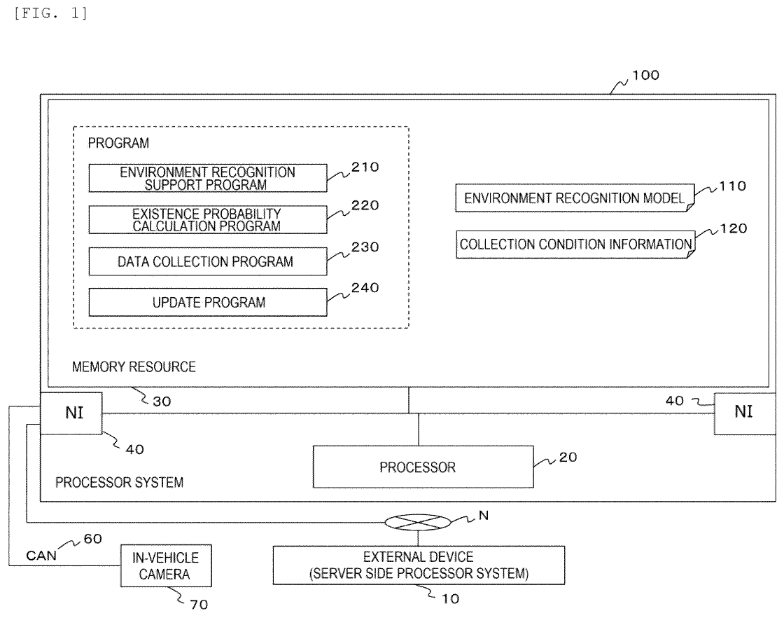

FIG. 1 is a diagram showing an example of a schematic configuration of a moving body side processor system 100. The moving body side processor system 100 is a processor system that collects data of requested contents based on information communication with an external device 10 (including the server side processor system in the present embodiment) and transmits the data to the external device 10.

### <<External Device 10 (Including Server Side Processor System)>>

The external device 10 as viewed from the moving body side processor system 100 includes the server side processor system. The external device 10 collects information to be used for processing executed by the moving body side processor system 100 and transmits the information to the processor system. In addition, the external device 10 acquires information transmitted from the moving body side processor system 100 from the processor system, and executes various kinds of processing using the information.

### <<Detailed Description of Moving Body Side Processor System 100>>

In the moving body side processor system 100, a processor 20 reads various programs and various kinds of information stored in a memory resource 30 to execute existence probability calculation processing and collection data transmission processing to be described later.

As an example, the moving body side processor system 100 is implemented by being incorporated into an electronic control unit (ECU) that performs image recognition using image data captured by an in-vehicle camera. However, an installation destination of the moving body side processor system 100 is not particularly limited, and may be, for example, another ECU, a unit, and a device in the moving body capable of acquiring image data of an in-vehicle camera 70 via a controller area network (CAN) 60 and transmitting generated information or collected image data to the server side processor system.

As shown in FIG. 1, the moving body side processor system 100 includes the processor 20, the memory resource 30, and a network interface device (NI 40). The moving body side processor system 100 may include a user interface device (UI) as in the server side processor system.

The processor 20 is a calculation device that reads various programs stored in the memory resource 30 and executes processing corresponding to each program. Examples of the processor 20 include a micro-processor, a central processing unit (CPU), a graphics processing unit (GPU), a field programmable gate array (FPGA), or another semiconductor device that can perform calculation.

The memory resource 30 is a storage device that stores various kinds of information. Specifically, the memory resource 30 is a nonvolatile or volatile storage medium such as a random access memory (RAM) or a read only memory (ROM). The memory resource 30 may be, for example, a rewritable storage medium such as a flash memory, a hard disk, or a solid state drive (SSD), a universal serial bus (USB) memory, a memory card, or a hard disk.

The NI 40 is a communication device that performs information communication with the external device 10. The NI 40 performs information communication with the external device 10 via a predetermined communication network N. It is assumed that information communication between the moving body side processor system 100 and the external device 10 is executed via the NI 40 unless otherwise identified.

A part or all of configurations, functions, processing methods, and the like of the moving body side processor system 100 may be implemented by hardware by, for example, designing with an integrated circuit. In the moving body side processor system 100, a part or all of the functions can be implemented by software, or can be implemented by cooperation of software and hardware. The moving body side processor system 100 may use hardware having a fixed circuit, or may use hardware capable of changing at least a part of the circuit.

In addition, when the moving body side processor system 100 includes a UI, the moving body side processor system 100 can also implement the system by a user (operator) performing a part or all of the functions and processing implemented by each program. The moving body side processor system 100 may entrust a part of output processing to a user and a part of input processing from the user to a processor system outside the system (referred to as an external processor system) such as a smartphone or tablet instead of the moving body side processor system 100. In such a case, the moving body side processor system 100 (or its processor and program) may perform the following in order to execute other parts of each processing or program.

Instead of the output to the user using the UI, data necessary for the output to the user is transmitted to the external processor system via the NI 40. As an example of the data, data to be output and data for generating output data in another processor system may be considered, and a program or Web data describing processing of outputting to the user by the external processor system may be used.

The moving body side processor system 100 receives data indicating a user input or an operation from the external processor system via the NI 40 instead of receiving an input or an operation from the user using the UI. From another perspective, the meaning of outputting data to the user may not only include the moving body side processor system 100 itself outputting the data, but may also include having another entity other than the processor system 100 output the data (using the processor system 100 to perform the output). The meaning of input or operation reception from the user may include not only direct output or reception to and from the user of the moving body side processor system 100 but also indirect reception by the moving body side processor system 100.

The database and various kinds of information in the memory resource 30 described below may have a data structure other than a file or the like or a database as long as it is an area capable of storing data. One program may also serve as a plurality of programs. In addition, a plurality of programs may serve as one program. That is, one or more programs may perform the processing of each shown program.

The program executed by the moving body side processor system 100 may be stored in a nonvolatile storage medium which can be read by the processor system 100. The program stored in the nonvolatile storage medium may be directly read by the moving body side processor system 100, or a processor system for program distribution may read the program from the medium and then transmit (distribute) the program from the processor system for program distribution to the moving body side processor system 100. As an example of the nonvolatile storage medium, a nonvolatile memory described as the memory resource is considered as an example, and other optical disk media may be used.

### <<Environment Recognition Model 110>>

An environment recognition model 110 is an AI model that recognizes a data collection environment in which a moving body is placed (present) by image recognition. The environment recognition model 110 is not limited to the AI model, but in the present embodiment, a case of the AI model will be described as an example.

The environment recognition model 110 recognizes a data collection environment in which a moving body (automobile) is placed using image data captured by the in-vehicle camera. Specifically, the environment recognition model 110 performs image recognition using the image data as input information, and outputs, as a recognition result, information (elements) indicating a data collection environment in which a moving body is placed, such as a type (for example, a car, a bicycle, or a person), the number, a size, a position, and a distance between objects of an object reflected in the image.

In addition to the image data, the environment recognition model 110 may output information indicating a data collection environment as a recognition result by supplementarily using information output from various sensors such as a millimeter wave radar and a light detection and ranging (LiDAR) mounted on an automobile, for example.

### <<Collection Condition Information 120>>

Collection condition information 120 is information in which a collection condition of training data (the image data in the present embodiment) used for machine learning of the environment recognition model 110 is registered. Specifically, the collection condition information 120 has a plurality of collection conditions in which different contents (values) are designated for a common collection request item.

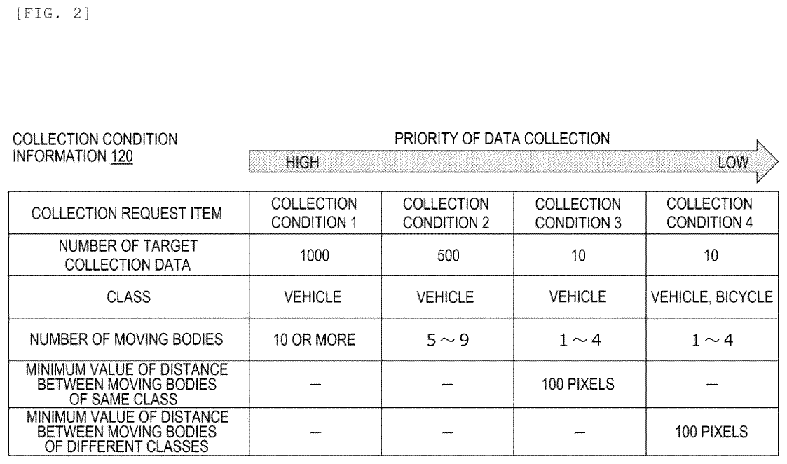

FIG. 2 is a diagram showing an example of the collection condition information 120. The shown collection condition information 120 shows an example at a stage where the maturity of the environment recognition model 110 is low. In the collection condition information 120, the highest priority is designated for data collection under a collection condition 1, which has a large number of target collection data and contains a larger number of vehicles in the image data to be collected than other collection conditions. In the collection condition information 120, the priority of the data collection is lowered from the collection condition 2 to the collection condition 4, and accordingly, the number of target collection data and the number of vehicles included in the image data are designated to be small.

A “class” of a collection request item is information indicating types of objects included in the image data, and in the shown example, a moving body such as a vehicle or a bicycle is a target. A “minimum value of a distance between moving bodies of the same class” is information indicating a minimum distance between moving bodies of the same type designated by the class, that is, vehicles on the image data, and is 100 pixels in the shown example. A “minimum value of a distance between the moving bodies of different classes” is information indicating a minimum distance on the image data between moving bodies of different types designated by the class, that is, a vehicle and a bicycle, and is 100 pixels in the shown example.

The contents (values) of these collection request items correspond to at least a part of the information output from the environment recognition model 110 (for example, the number of objects such as vehicles and bicycles, and the distance between objects).

The collection request item may further include an item of an element effective for environment recognition, such as brightness (luminance) of the image data.

A content (value) for such a collection request item may be designated in advance by the user (operator) for each collection condition. The collection condition information 120 may be acquired by the moving body side processor system 100 via the server side processor system and stored in the memory resource 30.

### <<Environment Recognition Support Program 210>>

An environment recognition support program 210 supports recognition of the data collection environment by the environment recognition model 110. Specifically, the environment recognition support program 210 acquires image data output from an in-vehicle camera and inputs the image data to the environment recognition model 110. In addition, the environment recognition support program 210 acquires a recognition result output from the environment recognition model 110, that is, information such as the type, the number, the size, and the position of the object, and the distance between objects captured in the image, and inputs the information to an existence probability calculation program 220 and a data collection program 230.

Unless otherwise identified below, it is assumed that processing such as input of the image data to the environment recognition model 110, acquisition of the recognition result output from the environment recognition model 110, and input of the recognition result to the existence probability calculation program 220 and the data collection program 230 is executed by the environment recognition support program 210.

### <<Existence Probability Calculation Program 220>>

The existence probability calculation program 220 calculates an existence probability of the data collection environment of the moving body for each collection condition using the recognition result of the environment recognition model 110. Specifically, the existence probability calculation program 220 calculates a value corresponding to the collection request item of the collection condition information 120, such as an average value of the number of vehicles or bicycles captured in the image data or an average value of inter-object distances between the automobiles or between an automobile and a bicycle, using the recognition result of a plurality of pieces of image data captured in a predetermined period (for example, several seconds to several minutes).

The existence probability calculation program 220 compares a calculation result with each collection condition, and calculates a ratio of an occurrence frequency of an event matching the content of the collection request item as the existence probability of the data collection environment for each collection condition. The existence probability calculation program 220 transmits the calculated existence probability to the server side processor system.

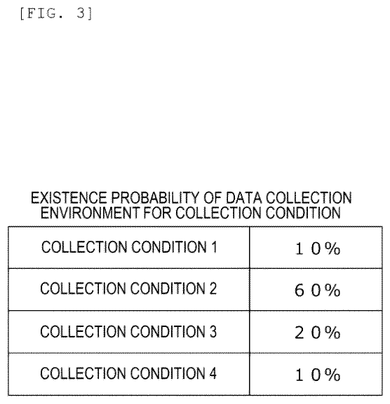

FIG. 3 is a diagram showing an example of the existence probability of the data collection environment for the collection condition. As shown in the drawing, the existence probability of the data collection environment of the moving body calculated by the existence probability calculation program 220 is associated with each collection condition. The existence probability calculation program 220 repeatedly calculates the existence probability of the data collection environment for the collection condition constantly, using the recognition result of the image data continuously captured by the in-vehicle camera 70. In addition, the existence probability calculation program 220 determines whether the calculated latest existence probability is changed from the previous (most recent) existence probability. Specifically, the existence probability calculation program 220 compares the latest existence probability with the most recent existence probability, and determines that the existence probability is changed when the collection condition associated with the highest existence probability is changed.

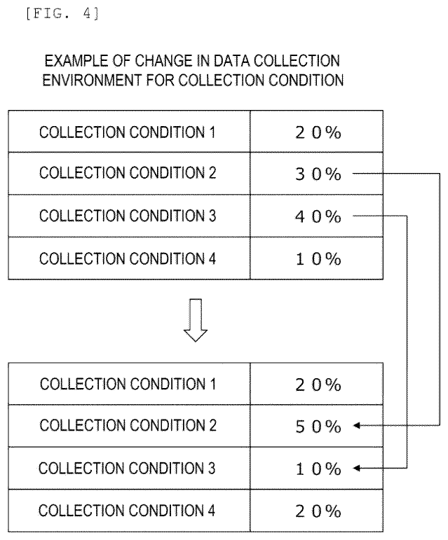

FIG. 4 is a diagram showing an example of a change in the data collection environment for the collection condition. As shown in the drawing, in the most recent existence probability, the collection condition 3 is the highest existence probability (40%). On the other hand, in the latest existence probability, the highest existence probability (50%) is changed to the collection condition 2. The existence probability calculation program 220 determines that the existence probability is changed when the collection condition having the highest existence probability is changed (changed from the collection condition 3 to the collection condition 2).

When there is a change in the existence probability, the existence probability calculation program 220 transmits the changed existence probability to the server side processor system.

### <<Data Collection Program 230>>

The data collection program 230 collects the image data that matches allocated collection conditions. Specifically, the data collection program 230 compares the recognition result acquired from the environment recognition model 110 with a collection condition allocated by the server side processor system. When the content (value) of the collection request item in the collection condition matches the recognition result, the data collection program 230 identifies the image data to be used for calculating the recognition result. The data collection program 230 collects the image data identified from image data captured by the in-vehicle camera 70 and transmits the image data to the server side processor system.

### <<Update Program 240>>

The update program 240 updates the environment recognition model 110 in the memory resource 30. Specifically, the update program 240 updates the environment recognition model 110 in the memory resource 30 by acquiring the environment recognition model 110 updated by the server side processor system using the collected image data (training data) and replacing the environment recognition model 110 with the existing environment recognition model 110 in the memory resource 30.

An example of the configuration of the moving body side processor system 100 is described above.

### <Configuration of Server Side Processor System>

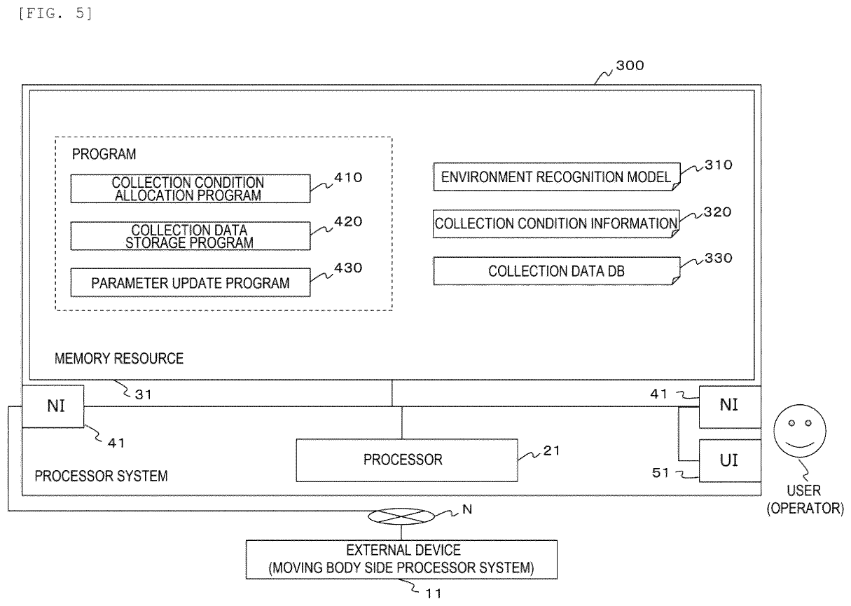

FIG. 5 is a diagram showing an example of a schematic configuration of the server side processor system 300. The server side processor system 300 is a server device that provides various cloud services to the external device 11 (including the moving body side processor system 100 in the present embodiment) based on information communication with the external device 11.

### <<External Device 11 (Including Moving Body Side Processor System 100)>>

The external device 11 as viewed from the server side processor system 300 includes the moving body side processor system 100. The external device 11 transmits, to the processor system, information to be used for processing executed by the server side processor system 300. In addition, the external device 11 acquires information output from the server side processor system 300 from the processor system 300 and executes various kinds of processing using the information.

### <<Detailed Description of Server Side Processor System 300>>

The server side processor system 300 reads various programs and various kinds of information stored in a memory resource 31 to execute data collection processing to be described later by a processor 21.

The server side processor system 300 is, for example, a server computer or a computer such as a personal computer, a tablet terminal, or a smartphone capable of providing a cloud service, and is a system including at least one or more of these computers.

As shown, the server side processor system 300 includes the processor 21, the memory resource 31, a NI 41, and a UI 51.

Since the processor 21, the memory resource 31, and the NI 41 are the same as those of the moving body side processor system 100, a detailed description thereof will be omitted. The UI 51 is an input device that inputs an instruction of a user (operator) to the server side processor system 300 and an output device that outputs information generated by the server side processor system 300. Examples of the input device include a keyboard, a touch panel, a pointing device such as a mouse, and a voice input device such as a microphone. Examples of the output device include a display, a printer, and a voice synthesis device. Unless otherwise identified in the following description, it is assumed that a user operation (for example, input and output of information and a processing execution instruction) on the server side processor system 300 is executed via the UI 51.

A part or all of configurations, functions, processing methods, and the like of the server side processor system 300 may be implemented by hardware by, for example, designing with an integrated circuit. In the server side processor system 300, a part or all of the functions may be implemented by software or may be implemented by cooperation of software and hardware. The server side processor system 300 may use hardware having a fixed circuit, or may use hardware capable of changing at least a part of the circuit.

The server side processor system 300 can also implement the system by a user (operator) performing a part or all of the functions and processing implemented by each program.

A database and various kinds of information in the memory resource 31 described below may have a data structure other than a file or the like or a database as long as the data structure has an area where data can be stored. One program may also serve as a plurality of programs. In addition, a plurality of programs may serve as one program. That is, one or more programs may perform the processing of each shown program.

The program executed by the server side processor system 300 may be stored in a nonvolatile storage medium readable by the processor system 300. The program stored in the nonvolatile storage medium may be directly read by the server side processor system 300, or a processor system for program distribution may read the program from the medium and then transmit (distribute) the program from the processor system for program distribution to the server side processor system 300. As an example of the nonvolatile storage medium, a nonvolatile memory described as the memory resource 31 is considered as an example, and other optical disk media may be used.

### <<Environment Recognition Model 310>>

The environment recognition model 310 is an AI model that recognizes a data collection environment in which a moving body is placed (exists) by the image recognition. The environment recognition model 310 is updated by a parameter update program 430 using the training data (image data) collected by the moving body side processor system 100, and the updated environment recognition model 310 is transmitted to the moving body side processor system 100. The environment recognition model 310 before the update is a master model, and is the same AI model as the environment recognition model 110 stored in the memory resource 30 of the moving body side processor system 100. Therefore, a detailed description thereof will be omitted here.

### <<Collection Condition Information 320>>

Collection condition information 320 is information in which a collection condition of training data (the image data in the present embodiment) used for machine learning of the environment recognition model 310 is registered. Since the collection condition information 320 is the same information as the collection condition information 120 stored in the memory resource 30 of the moving body side processor system 100, a detailed description thereof will be omitted here.

### <<Collection Data DB 330>>

Collection data database (DB) 330 is a database for storing the training data (the image data) collected from the moving body side processor system 100. The server side processor system 300 uses the collection data stored in the collection data DB 330 as training data for machine learning of the environment recognition model 310.

### <<Collection Condition Allocation Program 410>>

A collection condition allocation program 410 allocates a corresponding collection condition to a moving body in a data collection environment in which the occurrence frequency of an event matching a predetermined collection condition is higher. Specifically, the collection condition allocation program 410 allocates each collection condition to an appropriate moving body based on the existence probability of the data collection environment for the collection condition of each moving body acquired from the moving body side processor system 100. Details of collection condition allocation processing will be described later.

The collection condition allocation program 410 also executes the collection condition allocation processing again when the data collection environment of the moving body changes and the changed existence probability is acquired from the moving body side processor system 100.

### <<Collection Data Storage Program 420>>

A collection data storage program 420 stores the image data acquired from the moving body side processor system 100 in the collection data DB 330. Specifically, the collection data storage program 420 acquires the image data collected based on the collection condition allocated to each moving body, and stores the image data in the collection data DB 330.

### <<Parameter Update Program 430>>

The parameter update program 430 updates the environment recognition model 310 using the image data (training data) collected by the moving body. Specifically, the parameter update program 430 acquires the training data from the collection data DB 330, and updates parameters of the model 310 such that image recognition accuracy of the environment recognition model 310 is improved (such that the maturity of the environment recognition model 310 is increased) by performing the machine learning of the environment recognition model 310 using the training data.

An example of the configuration of the server side processor system 300 is described above.

### <Flow of Data of Present System>

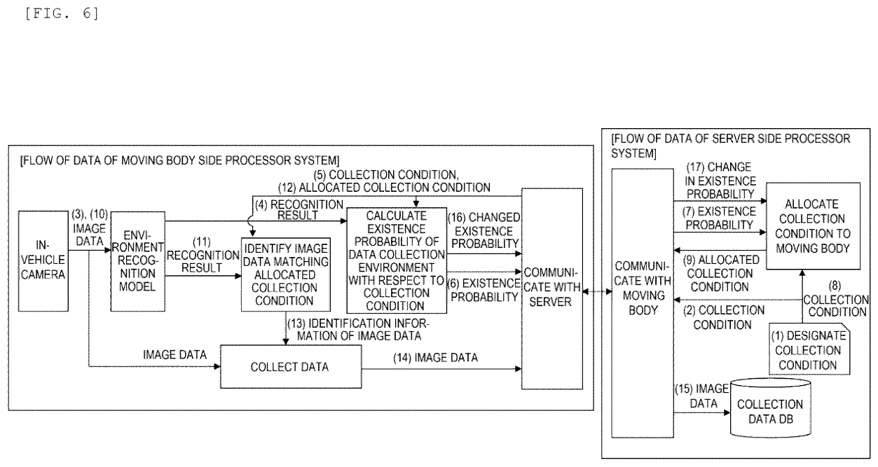

FIG. 6 is a diagram showing an example of a flow of data in the present system. Hereinafter, the flow of data will be described with reference to reference numerals (1) to (17) in the drawings.

As shown in the drawing, the server side processor system 300 receives designation of the content (value) of the collection request item in the collection condition information 120 from a user (operator) (1). The server side processor system 300 transmits the collection condition information 120 (2) to the moving body side processor system 100. The moving body side processor system 100 stores the acquired collection condition information 120 in the memory resource 30.

The moving body side processor system 100 inputs the image data (3) captured by the in-vehicle camera 70 to the environment recognition model 110. The moving body side processor system 100 calculates an existence probability (6) of the data collection environment for the collection condition using a recognition result (4) output from the environment recognition model 110 and the collection condition information 120 (5) in the memory resource 30, and transmits the existence probability (6) to the server side processor system 300.

The server side processor system 300 uses the existence probability (7) acquired from the moving body side processor system 100 and the collection condition information 320 (8) to allocate a corresponding collection condition to a moving body in a data collection environment in which the occurrence frequency of an event matching each collection condition is higher, and transmits the allocated collection condition (9) to the corresponding moving body side processor system 100. The moving body side processor system 100 temporarily stores the allocated collection condition in the memory resource 30.

In addition, the moving body side processor system 100 inputs the image data (10) output from the in-vehicle camera 70 to the environment recognition model 110, and identifies the image data matching the collection condition (12) using the recognition result (11) output from the environment recognition model 110 and the allocated collection condition (12). The moving body side processor system 100 collects the image data matching the allocated collection condition based on identification information (13) of the identified image data, and transmits the image data (14) to the server side processor system 300.

When the server side processor system 300 acquires the image data (15) matching the collection condition from the moving body side processor system 100, the server side processor system 300 stores the image data (15) in the collection data DB 330.

The moving body side processor system 100 constantly performs environment recognition using the image data (10) output from the in-vehicle camera 70, and repeatedly calculates the existence probability of the data collection environment for the collection condition using the recognition result (4). When there is a change in the existence probability, the moving body side processor system 100 transmits the changed existence probability (16) to the server side processor system 300.

When there is a change in the existence probability of the moving body in the data collection environment, the server side processor system 300 acquires the changed existence probability (17), and allocates, based on the existence probability after the change, an appropriate collection condition to each moving body again. The server side processor system 300 transmits the allocated collection condition (9) to the corresponding moving body side processor system 100.

The moving body side processor system 100 collects the image data (14) serving as the training data based on the re-allocated collection condition (12), and transmits the image data (14) to the server side processor system 300. In the present system, such a series of processing is continuously executed.

An example of the flow of data in the present system is described above.

### <Processing of Moving Body Side Processor System 100 and Server Side Processor System 300>

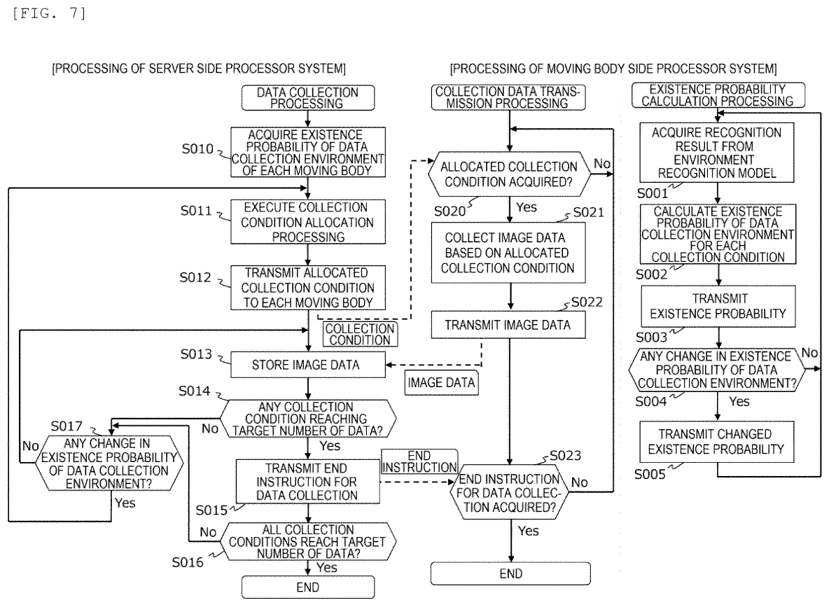

FIG. 7 is a flowchart showing an example of existence probability calculation processing and collection data transmission processing, which are processing of the moving body side processor system 100, and the data collection processing, which is processing of the server side processor system 300. Broken arrows in the drawings indicate flows of data and instructions.

### <<Existence Probability Calculation Processing>>

The existence probability calculation processing is processing of calculating the existence probability of the data collection environment of the moving body with respect to each collection condition. The processing is started, for example, when an ignition of the moving body is in an ON state.

When the processing is started, the existence probability calculation program 220 acquires a recognition result from the environment recognition model 110 (step S001). Specifically, the existence probability calculation program 220 acquires a recognition result including information (element) indicating a data collection environment in which the moving body is placed, such as the type and the number of objects, and the inter-object distance of the objects captured in the image data.

Next, the existence probability calculation program 220 calculates the existence probability of the data collection environment for each collection condition (step S002). Specifically, the existence probability calculation program 220 calculates an average value of the number of vehicles or bicycles reflected in the image data, an average value of the inter-object distances between automobiles or between an automobile and a bicycle, or the like, using the recognition result of a plurality of pieces of image data captured in a predetermined period (for example, several seconds to several minutes).

The existence probability calculation program 220 compares a calculation result with each collection condition, and calculates, as the existence probability of the data collection environment for each collection condition, a ratio of the occurrence frequency of an event matching the content of the collection request item. The existence probability calculation program 220 transmits the calculated existence probability to the server side processor system 300 (step S003).

Next, the existence probability calculation program 220 determines whether there is a change in the existence probability of the data collection environment (step S004). Specifically, the existence probability calculation program 220 calculates the latest existence probability in the same manner as in step S002. The existence probability calculation program 220 compares the latest existence probability with the most recent existence probability, and determines that the existence probability is changed when the collection condition corresponding to the highest existence probability is changed.

When it is determined that there is no change (No in step S004), the existence probability calculation program 220 returns the processing to step S001. On the other hand, when it is determined that there is a change (Yes in step S004), the existence probability calculation program 220 transmits the changed existence probability to the server side processor system 300 (step S005), and returns the processing to step S001.

The existence probability (including the changed existence probability) transmitted to the server side processor system 300 is stored in the memory resource 31 of the processor system 300.

### <<Data Collection Processing>>

The data collection processing is processing of collecting, from each moving body side processor system 100, image data matching the collection condition allocated to each moving body. The processing is started, for example, when an execution instruction is received from the user, or when existence probabilities are acquired from the moving body side processor systems 100 of all the target moving bodies.

When the processing is started, the collection condition allocation program 410 acquires the existence probability of the data collection environment of each moving body from the memory resource 31 (step S010).

The collection condition allocation program 410 performs the collection condition allocation processing using the acquired existence probability (step S011). Specifically, the collection condition allocation program 410 compares the collection condition information 320 with the existence probability. The collection condition allocation program 410 allocates the collection condition to the moving body having the highest existence probability for each collection condition.

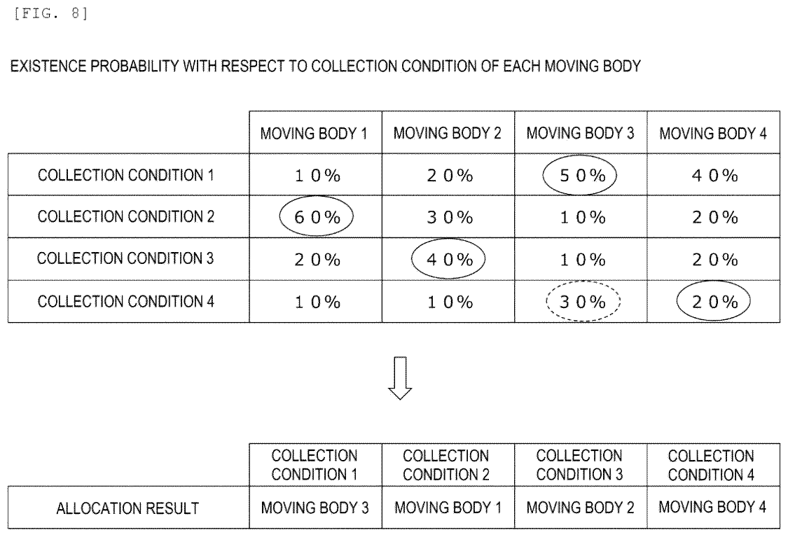

FIG. 8 is a diagram showing an example of the existence probability of each moving body with respect to the collection condition. As shown in the drawing, the existence probability surrounded by an ellipse is the highest existence probability corresponding to each collection condition. That is, for the collection condition 1, the existence probability 50% of a moving body 3 is the highest existence probability. For the collection condition 2, the existence probability 60% of a moving body 1 is the highest existence probability. For the collection condition 3, the existence probability 40% of a moving body 2 is the highest existence probability. For the collection condition 4, the existence probability 30% (indicated by a broken-line ellipse in the drawing) of the moving body 3 is the highest existence probability.

The collection condition allocation program 410 allocates the collection condition corresponding to the moving body having the highest existence probability for each collection condition. Specifically, the moving body 3 having the highest existence probability is allocated to the collection condition 1. For the collection condition 2, the moving body 1 having the highest existence probability is allocated. For the collection condition 3, the moving body 2 having the highest existence probability is allocated. For the collection condition 4, although the moving body 3 (30%) has the highest existence probability, the collection condition 1 having a priority higher than that of the collection condition 4 is preferentially allocated to the moving body 3. Therefore, the collection condition allocation program 410 allocates the collection condition 4 to the moving body 4 having the second highest existence probability (20%). As a result, the collection condition allocation program 410 outputs the shown allocation results. When the collection condition allocation program 410 allocates the corresponding collection condition to each moving body, the collection condition allocation program 410 ends the collection condition allocation processing and shifts the processing to step S012.

In step S012, the collection condition allocation program 410 transmits the allocated collection condition to each moving body processor system.

Next, the collection data storage program 420 stores the image data acquired from the moving body processor system in the collection data DB 330 (step S013). Specifically, the collection data storage program 420 acquires the image data collected based on the collection condition allocated to each moving body, and stores the image data in the collection data DB 330.

Next, the collection data storage program 420 determines whether there is a collection condition under which the number of collected (stored) image data reaches the target number of data (step S014). Specifically, the collection data storage program 420 refers to the number of target collection data, which is the collection request item of the collection condition information 320, and determines whether the total number of image data acquired from the moving body side processor system 100 of the moving body to which each collection condition is allocated reaches the number of target collection data of each collection condition.

Then, when it is determined that there is a collection condition under which the target number of data is reached (Yes in step S014), the collection data storage program 420 transmits an end instruction for data collection to the moving body side processor system 100 of the moving body to which the collection condition is allocated (step S015), and shifts the processing to step S016. On the other hand, when it is determined that there is no collection condition under which the target number of data is reached (No in step S014), the collection data storage program 420 shifts the processing to step S017.

In step S016, the collection data storage program 420 determines whether the target number of data is reached for all the collection conditions. Then, when it is determined that all the collection conditions do not reach the target number of data (No in step S016), the collection data storage program 420 shifts the processing to step S017.

In step S017, the collection condition allocation program 410 determines whether there is a change in the existence probability of the data collection environment. Specifically, the collection condition allocation program 410 determines that there is a change in the existence probability of the data collection environment when the changed existence probability is transmitted from the moving body side processor system 100 (step S005 described above) and acquired.

When it is determined that there is a change (Yes in step S017), the collection condition allocation program 410 returns the processing to step S011 and performs the collection condition allocation processing again. Specifically, the collection condition allocation program 410 replaces the data collection environment of the moving body that is a transmission source of the changed existence probability with the changed existence probability, and performs the collection condition allocation processing again.

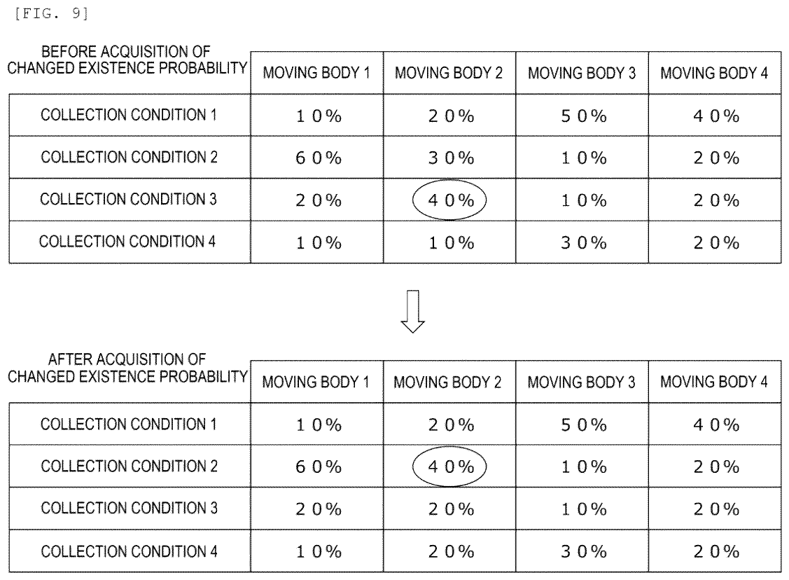

FIG. 9 is a diagram showing an example of a change in the existence probability. As shown in the drawing, the collection condition indicating the highest existence probability of the moving body 2 is changed from the collection condition 3 (40%) to the collection condition 2 (40%). When the collection condition allocation program 410 acquires such a changed existence probability, the collection condition allocation program 410 replaces the existence probability of the moving body 2 with the changed existence probability and performs the collection condition allocation processing again. When it is determined in step S017 that there is no change (No in step S017), the collection condition allocation program 410 shifts the processing to step S013. In step S013, the collection data storage program 420 acquires the image data transmitted from each moving body side processor system 100 and stores the image data in the collection data DB 330.

When it is determined in step S016 that all the collection conditions reach the target number of data (Yes in step S016), the collection data storage program 420 ends the data collection processing.

### <<Collection Data Transmission Processing>>

The collection data transmission processing is processing in which the moving body side processor system 100 transmits the collected image data to the server side processor system 300 based on the allocated collection condition. The processing is started, for example, after the ignition of the moving body is in an ON state or after the processing of step S003 in the existence probability calculation processing (after the existence probability is transmitted to the server side processor system 300).

When the processing is started, the data collection program 230 determines whether the allocated collection condition is acquired (step S020). Then, when it is determined that the information is not acquired (No in step S020), the data collection program 230 performs the processing of step S020 again. On the other hand, when it is determined that the information is acquired (Yes in step S020), the data collection program 230 shifts the processing to step S021.

In step S021, the data collection program 230 collects the image data based on the allocated collection condition. Specifically, the data collection program 230 compares the recognition result acquired from the environment recognition model 110 with the allocated collection condition, and collects the image data used for calculating the recognition result when the content (value) of the collection request item in the collection condition matches the recognition result. The data collection program 230 transmits the collected image data to the server side processor system 300 (step S022).

Next, the data collection program 230 determines whether the end instruction for data collection is acquired (step S023). Specifically, the data collection program 230 determines whether the server side processor system 300 acquires the end instruction transmitted in the processing of step S015.

When it is determined that the end instruction is not acquired (No in step S023), the data collection program 230 returns the processing to step S020. On the other hand, when it is determined that the end instruction is acquired (Yes in step S023), the data collection program 230 ends the collection data transmission processing.

A detail description of the processing executed by the moving body side processor system 100 and the server side processor system 300 is described above.

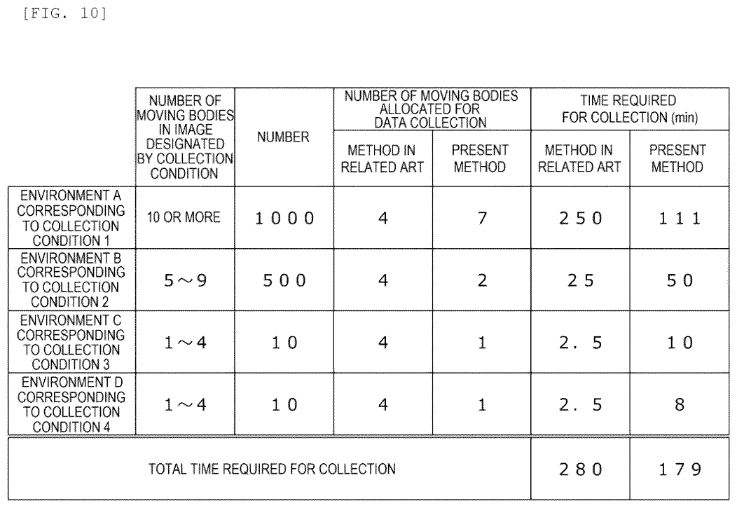

FIG. 10 is a diagram showing an example of efficiency comparison related to data collection in the present system and a method in the related art. As shown in the drawing, in the method in the related art, the data collection in environments A to D corresponding to the respective collection conditions is equally allocated to the same number of moving bodies without considering the data collection environment in which each moving body is placed. On the other hand, in the present system, the data collection of the corresponding collection condition is allocated to the moving body in the environment in which the occurrence frequency of the event matching each collection condition is higher. Therefore, in the example of the present system, the number of moving bodies to which the data collection is allocated is different in each of the environments A to D. In the present system, the data collection of a corresponding collection condition is allocated to a moving body in an environment in which the occurrence frequency of an event matching each collection condition is higher. Therefore, as indicated by a total time required for the collection, in the present system, the total time required for the collection is shorter than that in the method in the related art, which indicates that the image data matching the collection condition can be efficiently collected.

For the environment A in which the method in the related art takes the longest time for collection, in the present system, since the corresponding collection condition (the collection condition 1) is allocated to the moving body under the environment, thereby enabling data collection to be completed more efficiently and in a shorter time than with the method in the related art.

The first embodiment is described above.

According to such a present system, necessary data can be collected more efficiently. In particular, the present system can allocate a collection condition corresponding to a moving body under a data collection environment that matches a desired collection condition. Therefore, the present system can more efficiently collect the training data used for the machine learning of the environment recognition model.

In addition, even when the data collection environment of the moving body changes, the present system can allocate an appropriate collection condition again in consideration of the environment after the change. Therefore, the present system can always efficiently collect necessary data even when the data collection environment of the moving body changes.

In addition, the present system gives a priority according to the maturity of the environment recognition model to the data collection condition. Accordingly, the present system can efficiently collect the training data having different contents according to the maturity of the environment recognition model.

In the present system, it is possible to reduce the time required for the data collection and to reduce the number of moving bodies that perform the data collection. As a result, the present system can reduce the cost of collecting necessary data.

In addition, since the time required for data collection is shortened, the present system can update the parameters of the environment recognition model in a short cycle. Therefore, the present system can contribute to achievement of high environment recognition performance in the moving body.

### Second Embodiment

In the second embodiment, update of the environment recognition model 310 (110) will be described. Since a basic configuration of the present system is the same as that of the first embodiment, the same components and processing are denoted by the same reference numerals, and a detailed description thereof will be omitted.

The environment recognition model 310 (110) is executed by the parameter update program 430 of the server side processor system 300. Specifically, the parameter update program 430 updates the parameters of the environment recognition model 310 by performing the machine learning of the environment recognition model 310 using the training data (collected image data) acquired from the collection data DB 330.

In addition, in the updated environment recognition model 310 in which the parameters are updated, replication data is transmitted to the moving body side processor system 100, and the existing environment recognition model 110 before the update is replaced.

### <Flow of Data of Present System>

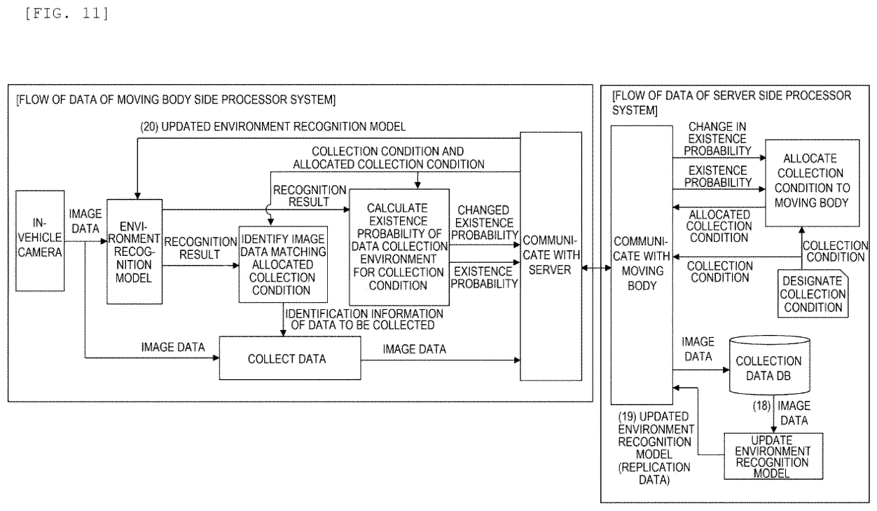

FIG. 11 is a diagram showing an example of a flow of data in the present system according to a second embodiment. Here, a flow of data related to parameter update of the environment recognition model 310 (110) will be described with reference to FIG. 11.

As shown in drawing, the server side processor system 300 updates the environment recognition model 310 by acquiring image data (18), which is training data, from the collection data DB 330 and performing machine learning of the environment recognition model 310 using the image data (18).

Replication data (19) of the updated environment recognition model 310 is transmitted to the moving body side processor system 100. The moving body side processor system 100 replaces the replication data (20) of the updated environment recognition model 310 with the existing environment recognition model 110 before the update.

### <Detailed Description of Parameter Update of Environment Recognition Model 110>

The parameter update program 430 updates (adjusts) the parameters of the environment recognition model 310 such that the higher the priority of the training data for data collection according to the maturity of the environment recognition model 310, the greater the contribution to the parameters to be updated.

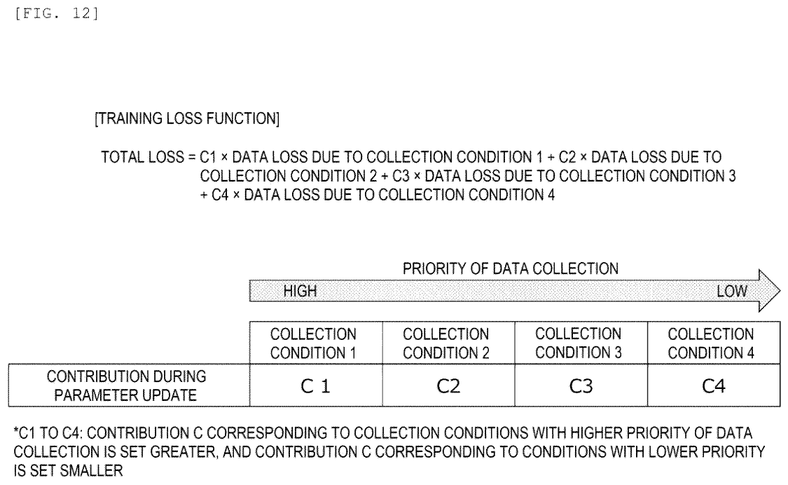

FIG. 12 is a diagram showing an example of a training loss function used for parameter update. The parameter update program 430 adjusts the parameters of the environment recognition model 310 so that a value of the total loss becomes smaller. The total loss is calculated by a sum of values obtained by multiplying the data loss due to each collection condition by coefficients (C1 to C4) in which larger values are set according to the priority of the data collection. The coefficients C1 to C4 may be designated in advance by the user.

The data loss due to the collection condition represents accuracy of the environment recognition model 310 with respect to a correct label of the training data collected based on each collection condition. The correct label is information indicating whether the collected image data is correct or incorrect with respect to a collection request item of the collection condition (for example, the number of moving bodies designated by the class). Such a correct label may be allocated by the user to each piece of collected image data, or may be mechanically allocated using a technique such as a neural network.

The parameter update program 430 uses a training loss function to update the parameters of the model 310 by machine learning the environment recognition model 310 using the training data so that the total loss becomes smaller, that is, the data loss due to the collection condition (the collection condition 1 in the shown example) having the highest data collection priority becomes smaller.

The second embodiment is described above.

According to the present system, the maturity (accuracy) of the environment recognition model can be more efficiently improved. In particular, the present system updates the parameters of the environment recognition model such that the higher the priority of the training data for data collection according to the maturity of the environment recognition model, the greater the contribution to the parameters to be updated. Accordingly, the present system can perform more efficient machine learning according to the maturity of the environment recognition model.

The computer related to the moving body side processor system 100 and the server side processor system 300 may function at least as a program distribution server that distributes the program in the memory resource 30(31) to another computer such that the program can be executed by the other computer.

The invention is not limited to the above-described embodiments and modifications, and includes various modifications within the scope of the same technical idea. For example, the above embodiments have been described in detail to facilitate understanding of the invention, and the invention is not necessarily limited to those including all the configurations described above. A part of a configuration of a certain embodiment can be replaced with a configuration of another embodiment, and a configuration of another embodiment can be added to a configuration of a certain embodiment. It is possible to add, delete, or replace a part of configurations of each embodiment with other configurations.

In the above description, control lines and information lines considered to be necessary for description are shown, and not all control lines and information lines in a product are necessarily shown. Actually, almost all configurations may be considered to be connected to one another.

### REFERENCE SIGNS LIST

100: moving body side processor system
20: processor
30: memory resource
40: network interface device (NI)
60: CAN
70: in-vehicle camera
110: environment recognition model
120: collection condition information
210: environment recognition support program
220: existence probability calculation program
230: data collection program
240: update program
300: server side processor system
21: processor
31: memory resource
41: network interface device (NI)
51: UI (user interface device)
310: environment recognition model
320: collection condition information
330: collection data DB
410: collection condition allocation program
420: collection data storage program
430: parameter update program
10(11): external device
N: communication network

1. A system comprising:
a moving body side processor system mounted on each of a plurality of moving bodies and including a processor and a memory resource; and
a server side processor system that is communicable with the moving body side processor system, that is mounted on a server computer, and that includes a processor and a memory resource, wherein
the memory resource of the moving body side processor system stores at least a data collection condition, an environment recognition model, an existence probability calculation program, and a data collection program,
by executing the existence probability calculation program, the processor of the moving body side processor system
calculates, based on a recognition result of a data collection environment in which the moving body is located, the recognition result being output by the environment recognition model using image data captured by a camera of the moving body, and the data collection condition, a ratio of an occurrence frequency of an event matching a predetermined data collection condition under the data collection environment as an existence probability of the data collection environment for the data collection condition,
the memory resource of the server side processor system stores at least the data collection condition and a collection condition allocation program,
by executing the collection condition allocation program, the processor of the server side processor system
uses the existence probability calculated by the moving body side processor system to allocate a data collection condition corresponding to the moving body under the data collection environment in which the occurrence frequency of the event matching the data collection condition is higher, and
by executing the data collection program, the processor of the moving body side processor system
collects image data matching the data collection condition allocated to the moving body from the image data captured by the camera.

2. The system according to claim 1, wherein
the memory resource of the server side processor system further stores a collection data storage program, and
by executing the collection data storage program, the processor of the server side processor system
stores the image data collected by the moving body in the memory resource as training data of the environment recognition model.

3. The system according to claim 1, wherein
the recognition result output by the environment recognition model in the moving body side processor system includes at least information indicating a type and the number of objects, and an inter-object distance of the objects captured in the image data captured by the camera.

4. The system according to claim 1, wherein
by executing the collection condition allocation program, the processor of the server side processor system
allocates, to the data collection condition, a data collection condition corresponding to the moving body having the highest existence probability.

5. The system according to claim 1, wherein
a priority of data collection is associated with the data collection condition, and
by executing the collection condition allocation program, the processor of the server side processor system
preferentially performs the allocation starting from the data collection condition having the higher priority.

6. The system according to claim 5, wherein
the priority of the data collection changes the associated data collection condition according to maturity of the environment recognition model.

7. Th e system according to claim 1, wherein
the data collection condition includes at least a condition related to a type and the number of objects, and an inter-object distance of the objects captured in the image data,

8. The system according to claim 1, wherein
by executing the existence probability calculation program, the processor of the moving body side processor system
continues calculation of the existence probability based on the recognition result newly output from the environment recognition model and the data collection condition, and
transmits, when the existence probability with respect to the data collection condition is changed, the changed existence probability to the server side processor system,
by executing the collection condition allocation program, the processor of the server side processor system
allocates a data collection condition to the moving body based on the changed existence probability, and
by executing the data collection program, the processor of the moving body side processor system
collects image data matching the data collection condition allocated to the moving body based on the changed existence probability from the image data captured by the camera as training data of the environment recognition model.

9. The system according to claim 8, wherein
a case in which the existence probability changes refers to a case in which the data collection condition for a corresponding destination with the highest existence probability changes,

10. The system according to claim 2, wherein
the memory resource of the server side processor system further stores a parameter update program, and
by executing the parameter update program, the processor of the server side processor system
updates a parameter of the environment recognition model by machine learning using the image data that is the training data in the memory resource.

11. The system according to claim 10, wherein
by executing the parameter update program, the processor of the server side processor system
updates the parameter such that a contribution of the image data collected based on the corresponding data collection condition to the parameter differs depending on a priority of the data collection condition.

12. The system according to claim 11, wherein
by executing the parameter update program, the processor of the server side processor system
updates the parameter such that the image data collected based on the data collection condition having a higher priority has a greater contribution to the parameter.

13. A moving body comprising:
a processor system including a processor and a memory resource, wherein
the memory resource stores at least a data collection condition, an environment recognition model an existence probability calculation program, and a data collection program,
by executing the existence probability calculation program, the processor
calculates, based on a recognition result of a data collection environment in which the moving body is located, the recognition result being output by the environment recognition model using image data captured by a camera of the moving body, and the data collection condition, a ratio of an occurrence frequency of an event matching a predetermined data collection condition under the data collection environment as an existence probability of the data collection environment for the data collection condition, and
by executing the data collection program, the processor
uses the data collection condition allocated by a processor system of a server computer that is communicable with the processor system of the moving body based on the existence probability to collect image data matching the data collection condition from the image data captured by the camera.

14. The moving body according to claim 13, wherein
by executing the existence probability calculation program, the processor
continues to calculate the existence probability based on the recognition result newly output from the environment recognition model and the data collection condition, and
by executing the data collection program, the processor
uses, when the existence probability with respect to the data collection condition changes, the data collection condition allocated based on the changed existence probability by the processor system of the server computer to collect image data matching the data collection condition from the image data captured by the camera.

15. A server computer having a processor system including a processor and a memory resource, wherein
the memory resource stores at least a data collection condition and a collection condition allocation program, and
by executing the collection condition allocation program, the processor
uses an existence probability indicating a ratio of an occurrence frequency of an event matching a predetermined data collection condition calculated based on a recognition result of a data collection environment in which the moving body is located, the recognition result being output by the environment recognition model and the data collection condition by a processor system of the moving body that is communicable with the processor system of the server computer, and
allocates a data collection condition corresponding to the moving body under the data collection environment in which the occurrence frequency of the event matching the data collection condition is higher.

16. The server computer according to claim 15, wherein
by executing the collection condition allocation program, the processor
when the existence probability calculated by the processor system of the moving body based on the recognition result newly output from the environment recognition model and the data collection condition changes,
allocates the data collection condition to the moving body based on the changed existence probability.

17. The server computer according to claim 15, wherein
the memory resource further stores a parameter update program, a collection data storage program, and image data collected by the processor system of the moving body based on the allocated data collection condition, and
by executing the parameter update program, the processor of the server computer
updates a parameter of the environment recognition model by machine learning using the image data in the memory resource as training data.

18. The server computer according to claim 17, wherein
by executing the parameter update program, the processor of the server computer
updates the parameter such that a contribution of the image data collected based on the corresponding data collection condition to the parameter differs depending on a priority of data collection associated with the data collection condition.

19. The server computer according to claim 18, wherein
by executing the parameter update program, the processor of the server computer
updates the parameter such that the image data collected based on the data collection condition having a higher priority has a greater contribution to the parameter.

20. The system according to claim 8, wherein
the memory resource of the server side processor system further stores a parameter update program, and
by executing the parameter update program, the processor of the server side processor system
updates a parameter of the environment recognition model by machine learning using the image data that is the training data in the memory resource,
by executing the parameter update program, the processor of the server side processor system
updates the parameter such that a contribution of the image data collected based on the corresponding data collection condition to the parameter differs depending on a priority of the data collection condition, and
by executing the parameter update program, the processor of the server side processor system
updates the parameter such that the image data collected based on the data collection condition having a higher priority has a greater contribution to the parameter.
